(19) United States
(12) Patent Application Publication
(10) Pub. No.: US 2026/0289789 A1
(43) Pub. Date: Sep. 24, 2026

(54) THREE-DIMENSIONAL INSTANCE SEGMENTATION IN VOXEL-BASED VOLUMETRIC IMAGE DATASETS

(71) Applicant: Carl Zeiss Microscopy GmbH, Jena (DE)

(72) Inventors: Jan-Philipp SIMEN, Munich (DE); Björn BARZ, Jena (DE); Anselm BRACHMANN, Jena (DE); Simon FRANCHINI, Munich (DE); Sandra LEMKE, Munich (DE)

(21) Appl. No.: 19/460,188

(22) Filed: Jan. 26, 2026

(30) Foreign Application Priority Data
Mar. 24, 2025 (DE) 10 2025 111 292.4

(51) Int. Cl. G06T 7/11; G06T 9/00; G06T 15/08

(52) U.S. Cl. CPC G06T 7/11; G06T 9/002; G06T 15/08; G06T 2200/04; G06T 2207/20081; G06T 2207/20084

(57) ABSTRACT

Latent feature vectors for a volumetric image dataset are processed in a voxel decoding branch in order to obtain voxel embeddings for the voxels of the volumetric image dataset. In addition, the latent feature vectors are processed in a transformer decoding branch in order to obtain segment embeddings for query vectors. Based on a combination of the voxel embeddings and segment embeddings, one or more instance-specific volumetric segmentation masks are generated for one or more structures imaged in the voxel-based volumetric image dataset.

### RELATED APPLICATION DATA

This application claims the benefit of German Application No. 10 2025 111 292.4, filed Mar. 24, 2025, the disclosure of which is incorporated herein by reference in its entirety.

### TECHNICAL FIELD

Various examples of the invention relate to a machine-learned model for three-dimensional instance segmentation in voxel-based volumetric image datasets. Various examples relate to the training and inference of a corresponding model.

### BACKGROUND

Instance segmentation of instances of one or more structure types in voxel-based volumetric image datasets (hereinafter simply 3D image dataset) is important for various applications.

One exemplary application requiring instance segmentation in 3D image datasets is that of quantifying porosity in ceramic materials. Specifically, mechanical properties, thermal conductivity and electrical conductivity all depend on the porosity of a ceramic material. Other properties that depend on the porosity of a ceramic material are for example the absorption of acoustic waves or the absorption of microwaves, growth properties of layers grown on a surface of a corresponding material, or superconductor properties for high-temperature superconductors. In order to obtain a 3D image dataset of a test sample, for example a ceramic material, it is possible for example to use X-ray tomography. One exemplary technique for 3D instance segmentation in such an application scenario is described in: Smith, J. D., et al. "Quantitative estimation of closed cell porosity in low density ceramic composites using X-ray microtomography." Scientific Reports 13.1 (2023): 127. In that document, a deep convolutional network is used to segment cross sections of pores in 2D cross-sectional images through the 3D image dataset. A 3D instance segmentation is then created based on the 2D segmentation masks in the 2D cross-sectional images, it being estimated, for this purpose, whether or not two instances positioned in adjacent 2D cross-sectional images are connected to one another. In such a technique, what is known as "oversegmentation" may occur, in which a certain instance (for example a certain pore in the material) is described by two separate segmentation masks. This then distorts for example statistics when determining a porosity. The distribution of the pore sizes is thereby distorted.

However, the determination of porosity in ceramic materials is just one specific application scenario for 3D instance segmentation. By way of example, it is possible to obtain 3D image datasets using X-ray tomography for the separator material of a lithium-ion battery. Polymer fibres may then be segmented. In this regard, see for example: Villarraga-Gómez, Herminso, et al. "Assessing rechargeable batteries with 3D X-ray microscopy, computed tomography, and nanotomography." Nondestructive Testing and Evaluation 37.5 (2022): 519-535.

The method for segmenting fibres described in that document is a two-stage process: (1) semantic segmentation using a deep neural network or other statistical models, (2) post-processing in order to separate instances (for example using connected component analysis). This instance segmentation method again has certain drawbacks. The process of semantic segmentation, followed by a post-processing algorithm that separates individual fibres, is prone to errors because it requires careful selection of hyperparameters in order to find a good balance between fibres that are not connected due to small gaps in the segmentation prediction and the combining of unconnected fibres that happen to be close to one another. In addition, a solution that works well on one dataset may fail on another.

Yet another example of 3D instance segmentation is described in: Abdollahzadeh, Ali, et al. "DeepACSON automated segmentation of white matter in 3D electron microscopy." Communications biology 4.1 (2021): 179. In that document, the 3D image datasets are obtained from a 3D electron microscope. The process comprises two deep machine-learned models that specialize in different structure types. Such a method also has certain drawbacks. In particular, manually optimized or adapted solutions – that is to say certain models that are adapted to a very specific structure type – cannot be generalized or are difficult to generalize. The effort to train the corresponding deep machine-learned models is therefore high. Experts have to create and adapt specialized models for the different structure classes.

### BRIEF SUMMARY OF THE INVENTION

There is thus a need for improved techniques to perform instance segmentation of instances of a certain structure type in voxel-based volumetric image datasets. There is in particular a need for techniques that eliminate or at least alleviate at least some of the abovementioned limitations and drawbacks.

This object is achieved by the features of the independent claims. The features of the dependent claims define embodiments.

A description is given below of techniques that enable instance segmentation of structures belonging to one or more structure types in voxel-based volumetric image datasets (3D image datasets). The techniques described herein make it possible to train a corresponding machine-learned model for different domains or also to apply it beyond the domains seen in training. The techniques described herein make it possible to segment structures robustly, even if these structures have an aspect ratio that differs greatly from one (for example long and thin structures such as polymer chains). The techniques described herein avoid oversegmentation or undersegmentation. The techniques described herein may be used to limit implementation effort for new application scenarios.

A computer-implemented method comprises obtaining a voxel-based volumetric image dataset. The method also comprises generating one or more latent feature vectors for the volumetric image dataset based on a coding branch. The method furthermore comprises processing the one or more latent feature vectors in a voxel decoding branch in order to obtain voxel embeddings for the voxels of the volumetric image dataset. In addition, the method comprises processing the one or more latent feature vectors in a transformer decoding branch and for a sequence of query vectors in order to obtain segment embeddings for the query vectors. In addition, the method comprises generating one or more instance-specific volumetric segmentation masks for one or more structures imaged in the voxel-based volumetric image dataset based on a combination of the voxel embeddings and segment embeddings.

An electronic data processing device comprises a processor unit and a memory. The processor unit is configured to load program code from the memory and execute it, wherein the processor unit is configured, based on the program code, to obtain a voxel-based volumetric image dataset. The processor unit is furthermore configured, based on the program code, to generate one or more latent feature vectors for the volumetric image dataset based on a coding branch. The processor unit is furthermore configured, based on the program code, to process the one or more latent feature vectors in a voxel decoding branch in order to obtain voxel embeddings for the voxels of the volumetric image dataset. The processor unit is furthermore configured, based on the program code, to process the one or more latent feature vectors in a transformer decoding branch and for a sequence of query vectors in order to obtain segment embeddings for the query vectors. The processor unit is furthermore configured, based on the program code, to generate one or more instance-specific volumetric segmentation masks for one or more structures imaged in the voxel-based volumetric image dataset based on a combination of the voxel embeddings and segment embeddings.

The features set out above and features described below may be used not only in the applicable combinations that are explicitly set out, but also in other combinations or in isolation, without departing from the scope of protection of the present invention.

### BRIEF DESCRIPTION OF THE FIGURES

FIG. 1 schematically illustrates the processing of a voxel-based volumetric image dataset in a machine-learned model according to various examples.

FIG. 2 is a flowchart of an exemplary method.

FIG. 3 schematically illustrates an electronic data processing device according to various examples.

### DETAILED DESCRIPTION OF EXAMPLES

A description is given below of techniques for determining a 3D instance segmentation. The 3D instance segmentation in this case comprises 3D segmentation masks for each of multiple instances. The 3D segmentation masks describe, for each voxel of a voxel-based volumetric image dataset, whether or not the respective voxel is part of the corresponding instance. The 3D instance segmentation may optionally also include class information for each 3D segmentation mask of a corresponding instance. This may be useful when segmenting structures of multiple structure types. By way of example, it would be conceivable for three-dimensional cell objects of different cell types to be segmented.

A voxel-based volumetric image dataset (hereinafter simply 3D image dataset) is a 3D representation of data in which the volume is divided into small uniform cubes, called voxels. Each voxel represents a specific value or property of the volume, such as for example density, colour or intensity. Voxel-based volumetric image datasets must be distinguished in particular from 3D point clouds.

The 3D image datasets processed by way of the techniques described herein may be acquired by way of different imaging devices. By way of example, a 3D microscope that provides magnification could be used. It would be possible to use a light-sheet microscope. A magnetic resonance tomography device could be used. An X-ray tomography device could be used. A further example is positron emission tomography. A serial section electron microscope may also be used; in this case, a focused ion beam may be used to carry out layer by layer removal from a sample, typically a semiconductor sample, and a corresponding cross-sectional image of each layer may be created by way of the electron microscope. Generally speaking, a 3D electron microscope may be used to provide the 3D image datasets processed by way of the techniques described herein.

The structure types that are segmented may also vary, given this flexibility in terms of the application of the techniques for 3D instance segmentation described herein to different types of 3D image datasets. By way of example, semiconductor structures, material pores, polymer fibres, etc. may be segmented.

The techniques described herein are distinguished in particular in that one and the same model architecture may be applied to a large number of different types of 3D image datasets and also to a large number of different structure types. The models described herein for performing 3D instance segmentation are not particularly domain-specific, but rather may be applied across different domains.

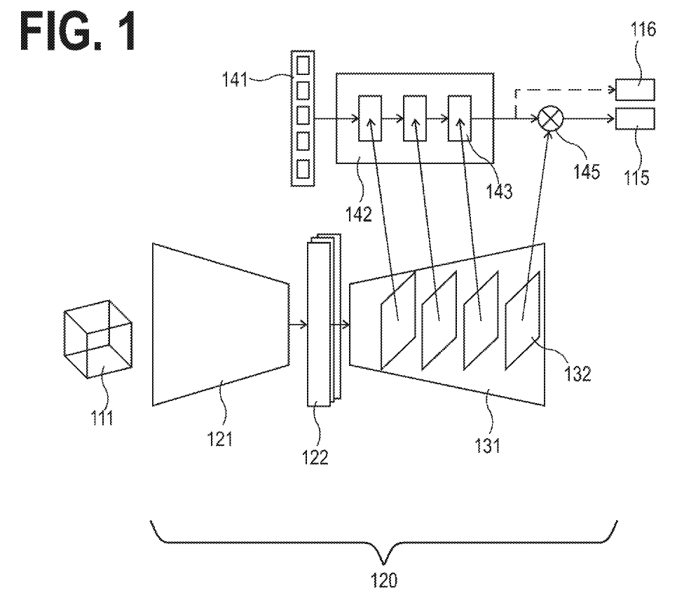

FIG. 1 illustrates a model 120 that generates instance segmentation data 115, 116 for a 3D image dataset 111. The model 120 is a machine-learned model that has multiple layers having corresponding machine-learned weights. The model 120 basically corresponds to the Mask2Former model described in Cheng, Bowen, et al. "Masked-attention mask transformer for universal image segmentation." Proceedings of the IEEE/CVF conference on computer vision and pattern recognition. 2022. However, the model 120 is capable of processing 3D image datasets, while the Mask2Former model only processes 2D images.

In order to process 3D image datasets, the model 120 includes the coding branch 121 (also referred to as a "backbone"), which is configured to determine one or more corresponding latent feature vectors 122 for the 3D image dataset 111. The one or more latent feature vectors 122 thus designate a latent representation of the respective 3D image dataset. Depending on the size of the 3D image dataset 111, that is to say depending on the number of voxels of the 3D image dataset 111, more or fewer latent feature vectors 122 may be determined. Each latent feature vector may in this case describe a specific subsection of the field of view covered by the 3D image dataset. Each feature vector may be a 1D array of scalar feature values. By way of example, a 3D array of feature vectors may be obtained; it is thereby possible to obtain a local relationship between the regions of the 3D image dataset that are coded by the feature vectors.

By way of example, it is possible to use a ResNet-based coding branch 121 that has one or more 3D convolution layers. Another example would be a coding branch based on a 3D vision transformer architecture, with 3D position codings being used here.

The one or more feature vectors 122 are then processed together in a voxel decoding branch 131 in order to obtain voxel embeddings 132 for the voxels of the volumetric image dataset.

In addition, each latent feature vector 122 is processed in a transformer decoding branch 142 for a sequence 141 of query vectors in order to obtain segment embeddings 143 for the query vectors. By way of example, the query vectors may be learned or else selected in some other way, for example depending on the 3D image dataset.

The transformer decoding branch 142 attends to multi-scale image feature maps generated by voxel decoding branch 133. Each decoding layer of the transformer decoding branch 142 contains a self-attention sublayer, a cross-attention sublayer and a feedforward sublayer. The self-attention sublayer makes it possible to ascertain dependencies between the query vectors. The cross-attention sublayer computes new features for the query vectors incorporating the voxel embeddings, by computing pairwise correlations between query vectors 141 and voxel embeddings 132, this being limited to specific local spatial regions in the feature maps (for example to the respective segmentation mask). This is also referred to as spatially limited attention. Spatially limited attention makes it possible to reduce storage requirements. The feedforward sublayer applies a pointwise transformation to each query embedding. Multiple layers of these operations are stacked such that it is possible to fine tune the queries in each layer by integrating information from the feature maps and by virtue of the representations influencing one another. Finally, the output of the transformer decoding branch is used to generate segmentation masks 115. For this purpose, based on a combination – block 145 – of the voxel embeddings 132 and segment embeddings 143, an instance-specific volumetric segmentation mask is generated for one or more structures or objects imaged in the 3D image dataset 111.

In addition, instance labels 116 may optionally be generated for each instance class based on the segment embeddings 143. It is thereby possible to distinguish between different structure types. It is thus possible, using the Mask2Former-based model 120, to perform the classification based on the segmentation mask data from the transformer decoding branch 142 (instead of performing a classification for each voxel).

In the example in FIG. 1, the transformer decoding branch 142 is coupled to multiple layers of the voxel decoding branch 131. In addition, the transformer decoding branch 142 – as described above – also uses spatially limited attention, for example by masking, for each of the multiple query vectors of the corresponding sequence 141. This corresponds to techniques as are known in principle – for two-dimensional images – for the Mask2Former model. However, both architectural features are optional. In some examples, it is thus possible to dispense with spatially limited attention and/or the coupling of the transformer decoding branch to the layers of the voxel decoding branch 131, for example as described for the MaskFormer model in Cheng, Bowen, Alex Schwing, and Alexander Kirillov. "Per-pixel classification is not all you need for semantic segmentation." Advances in neural information processing systems 34 (2021): 17864-17875.

A description will be given next of aspects related to the training of at least parts of the machine-learned model 120. The machine-learned weights of the model 120 are determined in one or more machine learning methods. Such machine learning methods are optimization methods, for example gradient descent methods. By way of example, what is known as the backpropagation algorithm may be used to determine the machine-learned weights. One or more loss functions are optimized in this case. The loss function may for example describe a deviation of the instance segmentation data 115, 116, as predicted by the model 120 for a 3D training image dataset, from a corresponding ground truth. The ground truth may for example include annotations of individual instances for a complete 3D training image dataset. However, it would also be conceivable for only a subsection of a 3D training image dataset to be annotated – this is helpful for limiting annotation effort. It is then possible to use a loss function limited to this subsection. No loss value is computed outside the subsection, and the weights are accordingly also not adjusted. In principle, the weights in different parts of the model 120 may be adjusted during training. The ground truth annotations may in this case, for each voxel in the corresponding subsection, indicate an assignment of the respective voxel to a corresponding instance (and where applicable instance class) and/or indicate an assignment of the respective voxel to the background. Using background annotations makes it possible in particular to achieve a steep learning curve for the training, even for comparatively limited extents of the subsection. By way of example, the query vectors of the corresponding sequence 141 could be determined in the training. As an alternative or in addition, the weights in the transformer decoding branch 142 and/or in the voxel decoding branch 131 and/or in the coding branch 121 may also be adjusted. In some examples, it may be helpful for the weights of the coding branch 121 to be fixed and trained separately from the query vectors and/or the decoding branches 131, 142 ("bootstrapping"). Training of at least parts of the machine-learned model 120 may for example be performed for different sample types (called "fine tuning"). By way of example, new training could be initiated if a new structure type is recognized in the 3D image dataset. By way of example, for this purpose, it would be possible to perform anomaly detection, which knows structure types used in previous training and recognizes structure types not used in the previous training as an anomaly. A domain-specific adaptation may thereby be carried out. By way of example, it would be possible for the coding branch 121 not to be retrained in the case of relatively similar sample types, but for the sequence 141 of the query vectors to be retrained and/or the decoding branches 131, 142 to be retrained.

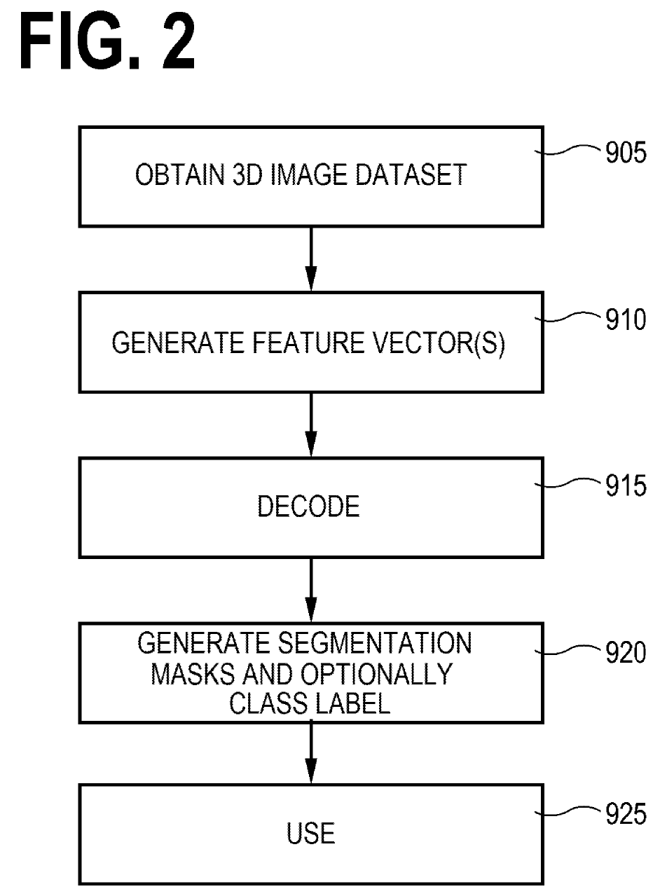

FIG. 2 is a flowchart of an exemplary method. The method from FIG. 2 may be carried out by a processor. For this purpose, the processor may load program code from a memory and execute this program code. The method from FIG. 2 concerns the generation of instance segmentation data for a 3D image dataset. By way of example, the method from FIG. 2 may use the machine-learned model 120 from FIG. 1.

In Box 905, the 3D image dataset is obtained. By way of example, the 3D image dataset may be obtained from a 3D imaging device, such as for example a 3D microscope. By way of example, Box 905 may comprise driving a corresponding 3D imaging device with appropriate control data in order to trigger image acquisition. However, it would also be conceivable for the 3D image dataset to be loaded from an image database in Box 905.

In Box 910, one or more feature vectors for the 3D image dataset from Box 905 are then generated. By way of example, multiple feature vectors, which code (for example overlapping) image regions of the 3D image dataset, may be created. It is thereby possible to process even particularly large 3D image datasets with limited memory resources. The feature vectors are each 1D array structures, and so the feature vector is generated by way of a suitable coding branch that translates 3D data into one or more 1D data structures. By way of example, a three-dimensional convolutional network, for example with a ResNet architecture having what are known as residual connections, may be used for this purpose. Corresponding techniques have already been discussed above in connection with FIG. 1: coding branch 121.

In various examples, a non-domain-specific coding branch may in particular be used. By way of example, a coding branch that has been trained for a large number of different domains could be used.

In Box 915, the one or more feature vectors from Box 910 are then decoded. This is carried out in parallel by way of a voxel decoding branch (FIG. 1: voxel decoding branch 131) and by way of a transformer decoding branch (cf. FIG. 1: transformer decoding branch 142). A MaskFormer or Mask2Former architecture may be used.

Domain-specific decoding branches may be used in various examples. By way of example, a domain-specific adjustment of the weights of the decoding branches (cf. FIG. 1: decoding branches 131, 142) could be carried out as part of what is known as "fine tuning" training, while the weights of the coding branch 121 are fixed. Specifically, the coding branch may be trained on a non-domain-specific basis. Such techniques are based on the finding that the extraction of certain latent image features by way of the coding branch 121 may be transferred robustly to different domains, while the generation of corresponding segmentation data should be adapted specifically to different domains in order to achieve sufficient robustness.

In Box 920, segmentation masks are then generated, in particular by combining the results of the voxel decoding branch with the results of the transformer decoding branch. Corresponding techniques have been discussed above in connection with FIG. 1: block 145. A respective segmentation mask is obtained for each instance of a structure. In principle, multiple structure types may be segmented at the same time; it is then helpful for a corresponding structure class label also to be obtained for each segmentation mask.

In Box 925, the segmentation data previously generated in Box 920 may be used. By way of example, it would be possible to drive a graphical user interface so as to output a superposition of the segmentation masks with the 3D image dataset. By way of example, respective 2D cross-sectional images of the 3D image dataset and the 3D segmentation masks could be computed and displayed. It would also be conceivable to perform an improved statistical evaluation based on the segmentation data. By way of example, a size distribution of segmented instances could be computed. By way of example, such a size distribution could be computed for each of multiple structure types. As an alternative or in addition, an average distance between adjacent instances could also be computed. A 3D density of the instances of a particular structure type could be computed. All such evaluations may be improved through the particularly robust and reliable generation of the segmentation masks.

The techniques described in FIG. 2 make it possible to enable particularly robust 3D instance segmentation able to be transferred to a large number of different domains. Compared to conventional techniques that use 2D segmentation of cross-sectional images and the subsequent connection of 2D segmentation masks, the techniques described herein are more robust to oversegmentation and may also be applied to certain structure types that for example have particularly thin and long shapes. It is in particular possible to segment non-convex shapes such as fibres, neurones or mitochondria using the techniques described herein. It is possible to use a non-domain-specific segmentation model suitable for robustly segmenting structures of different shapes and geometries and sizes.

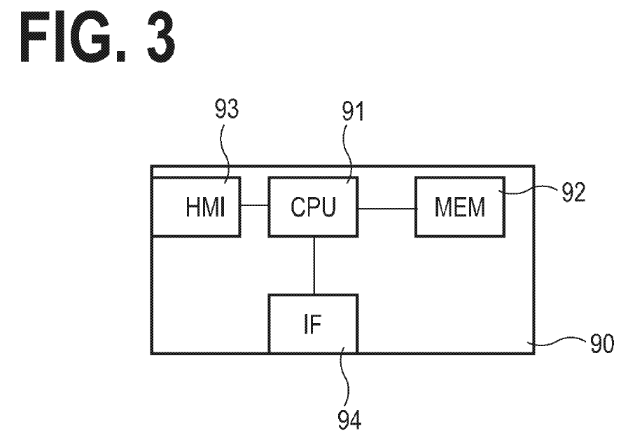

FIG. 3 schematically illustrates an electronic data processing device 90 having a processor unit 91 (implemented for example by a central processing unit, CPU, and a graphics processing unit, GPU) and a memory 92, and having a communication interface 94 and a user interface 93. The processor unit 91 is able to load program code from the memory 92 and execute the program code. When the processor unit 91 executes the program code, this has the effect that the processor unit 91 carries out techniques as described herein, for example: carrying out the method from FIG. 2; obtaining a 3D image dataset via the communication interface 94; processing the 3D image dataset in order to obtain instance-specific volumetric segmentation masks; outputting corresponding 3D image datasets, for example with superimposition of the volumetric segmentation masks, via a graphical user interface implemented by way of the user interface 93; etc.

In summary, a description has been given of machine-learned models that may particularly advantageously be used for 3D instance segmentation. Traditional solutions generally have a large number of hyperparameters, that is to say parameters that cannot be learned from the data, but rather have to be determined in some other way. Examples of hyperparameters include network depth, number of channels per level, learning rate, activation function, or generally type of model architecture used. In addition, the established methods usually require a post-processing step in order to obtain an instance segmentation from the output of the machine-learned model. Establishing both the appropriate configuration of hyperparameters and the appropriate post-processing steps requires manual work and a large number of experiments carried out by an experienced expert. The techniques used, based for example on the MaskFormer or Mask2Former architecture, reduce or eliminate this effort, since such models are able to be applied to a wide variety of datasets without further manual adjustments and directly provide 3D instance segmentation without data-specific post-processing.

It goes without saying that the features of the embodiments and aspects of the invention described above may be combined with one another. In particular, the features may be used not only in the combinations described but also in other combinations or on their own, without departing from the scope of the invention.

What is claimed is:

1. A computer-implemented method, comprising:
obtaining a voxel-based volumetric image dataset,
generating one or more latent feature vectors for the volumetric image dataset based on a coding branch,
processing the one or more latent feature vectors in a voxel decoding branch in order to obtain voxel embeddings for the voxels of the volumetric image dataset,
processing the one or more latent feature vectors in a transformer decoding branch and for a sequence of query vectors in order to obtain segment embeddings for the query vectors, and
based on a combination of the voxel embeddings and segment embeddings, generating one or more instance-specific volumetric segmentation masks for one or more structures imaged in the voxel-based volumetric image dataset.

2. The computer-implemented method according to claim 1,
wherein the transformer decoding branch is coupled to multiple layers of the neural voxel decoding branch and/or uses a spatially limited cross-attention between segment embeddings and voxel embeddings.

3. The computer-implemented method according to claim 1, wherein the method furthermore comprises:
obtaining a voxel-based volumetric training image dataset,
obtaining ground truth annotations limited to a subsection of the voxel-based volumetric training dataset, and
performing training in order to learn at least one of the sequence of the query vectors and weights of the transformer decoding branch based on the ground truth annotations,
wherein the training uses a loss function limited to the subsection of the voxel-based volumetric training dataset.

4. The computer-implemented method according to claim 3,
wherein the ground truth annotations, for each voxel in the subsection, indicate an assignment of the respective voxel to one or more structure instances or background.

5. The computer-implemented method according to claim 3, wherein the method furthermore comprises:
triggering performance of the training if a new structure type is recognized in the voxel-based volumetric image dataset.

6. The computer-implemented method according to claim 1,
wherein the voxel-based volumetric image dataset is acquired by an imaging device selected from the following group: three-dimensional microscope, light-sheet microscope, light-field microscope, confocal microscope, magnetic resonance tomograph, X-ray tomograph, positron emission tomograph, serial section electron microscope, 3D electron microscopy device.

7. The computer-implemented method according to claim 1,
wherein the coding branch comprises multiple three-dimensional convolutional layers.

8. The computer-implemented method according to claim 1,
wherein the coding branch is trained on a non-domain-specific basis,
wherein at least one of the transformer decoding branch and the voxel decoding branch is trained on a domain-specific basis.

9. An electronic data processing device comprising a processor unit and a memory, wherein the processor unit is configured to load program code from the memory and execute it, wherein the processor unit is configured, based on the program code, to carry out the following steps:
obtaining a voxel-based volumetric image dataset,
generating one or more latent feature vectors for the volumetric image dataset based on a coding branch,
processing the one or more latent feature vectors in a voxel decoding branch in order to obtain voxel embeddings for the voxels of the volumetric image dataset,
processing the one or more latent feature vectors in a transformer decoding branch and for a sequence of query vectors in order to obtain segment embeddings for the query vectors, and
based on a combination of the voxel embeddings and segment embeddings, generating one or more instance-specific volumetric segmentation masks for one or more structures imaged in the voxel-based volumetric image dataset.
